(19) United States
(12) Patent Application Publication
(10) Pub. No.: US 2005/0081000 A1
(43) Pub. Date: Apr. 14, 2005

(54) Providing a status indicator for a media job category

(76) Inventors: Stephen Gold, Fort Collins, CO (US); Robert Gibson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/683,752

(22) Filed: Oct. 10, 2003

(51) Int. Cl. G06F 12/00

(52) U.S. Cl. 711/154; 711/162

(57) ABSTRACT

Methods and systems are disclosed for providing a status indicator for a media job category. In one embodiment, the method comprises receiving a service level objective for a media job category, determining a status for each of a plurality of media jobs associated with the media job category, and providing a status indicator for the media job category based on the service level objective and the status for each of the plurality of media jobs.

### BACKGROUND OF THE INVENTION

The management of media used to backup data can be a complex process. Media jobs need to he performed on a routine basis. These media jobs may fall into different categories, such as media movement jobs that move media to a different location, device load jobs to load media into backup devices, and scratch initialization jobs to make media available for use by a backup application. Administrators may need to manually track each of these jobs to make sure they are completed in a timely fashion.

### SUMMARY OF THE INVENTION

Methods and systems are disclosed for providing a status indicator for a media job category. In one embodiment, a service level objective is received for a media job category. A status is determined for each of a plurality of media jobs associated with the media job category. A status indicator is provided for the media job category based on the service level objective and the status of each of the media jobs.

### BRIEF DESCRIPTION OF THE DRAWINGS

Illustrative embodiments in accordance with the invention are illustrated in the drawings in which:

FIG. 1 illustrates an exemplary configuration of a system that may be used to provide one or more status indicators for one or more categories of media jobs;

FIG. 2 is a flow diagram illustrating an exemplary method for providing a status indicator based on a service level objective for a media job category;

FIG. 3 illustrates an exemplary user interface that may be used to receive a service level objective for a media job category;

FIG. 4 is a flow diagram illustrating an exemplary method that may be used to provide a status indicator that may be used by the method of FIG. 2;

FIG. 5 is a flow diagram illustrating an exemplary method for providing a status indicator for media with known locations based on a second service level objective;

FIG. 6 illustrates an exemplary presentation to a user of status indicators for multiple media movement job categories;

FIG. 7 is a flow diagram illustrating an exemplary method for displaying overdue jobs that may be provided by the system of FIG. 1; and

FIG. 8 illustrates an exemplary presentation to a user of one or more overdue jobs.

### DETAILED DESCRIPTION

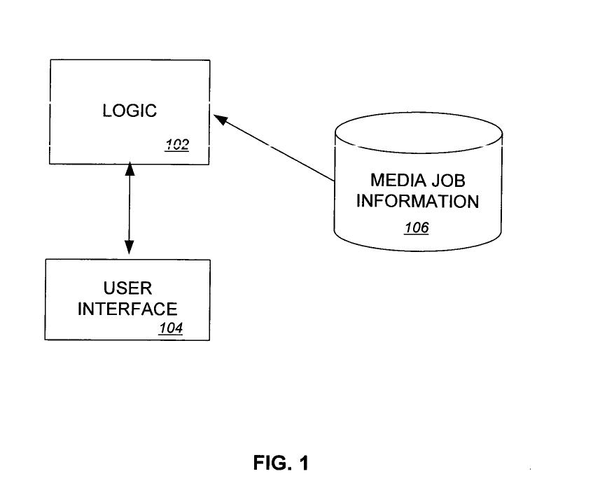

An exemplary configuration of a system that may be used to provide one or more status indicators for one or more media job categories is illustrated in FIG. 1. The system includes a user interface 104 that may be used to receive service level objectives for one or more media job categories. By way of example, media job categories may include one or more media movement categories (e.g., a vaulting category for moving media having protected data to a different location, a scratch category for moving media having data that exceeded a protected time period to a scratch bin, and check out request category for media check out jobs), a device load category, a scratch media initialization category, and other categories of media jobs for managing media used to backup data. The service level objectives may be stored for future reference in a location accessible by logic 102. As will be described in further detail below, user interface 104 may also be used to provide a status indicator for one or more of the media job categories based on the service level objective and the status of each of the media jobs associated with the media job category.

The system also includes logic 102 that is communicatively coupled to user interface 104. Logic 102 may determine a status of media jobs based on media job information 106. In one embodiment, media job information 106 may be a database that tracks the status of media jobs based on information received from a media manager (not shown). By way of example, media job information may include a due time associated with a media job. Logic 102 may be further configured to determine a status indicator for a media job category to provide to a user, such as an administrator or media operator. The status indicator may be determined based on the service level objective for the media job category and the media job information 106.

In the configuration described above, different components were described as being communicatively coupled to other components. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that logic 102, user interface 104 and media job information 106 may reside on the same or different physical devices. By way of example, user interface 104 may be a web browser on a remote client. It should also be appreciated that logic 102, user interface 104, and media job information 106 may be implemented in software, firmware, hardware or a combination of these.

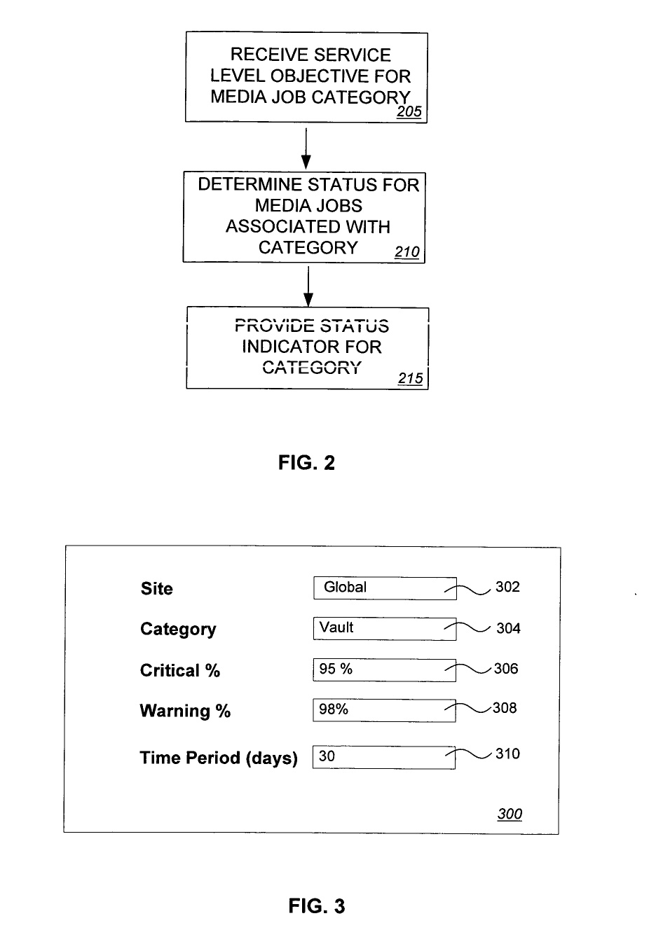

FIG. 2 illustrates an exemplary method for providing a status indicator for a media job category based on a service level objective for the media job category. A service level objective is received 205 for a media job category. The media job category may be a media movement category that includes media jobs to move media from one location to another, a device load category for media jobs that load media into a backup device that may be used as scratch media for a backup application, and a scratch media initialization category for media jobs that initialize scratch media into a scratch bin for use by one or more backup applications. By way of example, the media movement category may be a vaulting category for media jobs that move media having protected data to a different location, a scratch category for media jobs that move media having data that exceeded a protected time period to a scratch bin, or a check out request category for checking out media (e.g., to restore data). In one embodiment, the service level objective may be received 205 from a user via user interface 104.

The status of one or more media jobs associated with the category is then determined 210. The determination 210 of the status of media jobs may depend on the type of service level objective received 205. In one embodiment, the service level objective may be a desired percentage of media jobs that should be completed on time. In this embodiment, a determination 210 may be made on whether media jobs in the category were completed within the due time associated with the media job.

Due times may be calculated using the time the media job was created (or a user-defined job start time) and a predetermined time period to complete the job. The predetermined time period may be defined by a user of may be a default value and may vary depending upon the type of media job. By way of example, for media movement jobs, the predetermined time periods may be defined for onsite media movement, transit from onsite to offsite, and offsite media movement. Thus, the due time for a media movement job that moved media from a device to an offsite vendor may need to take into account all three time periods when calculating a due time. Additionally, in some embodiments, the predetermined time periods may have multiple levels (such as a warning and critical level). The critical time period may be used to determine if a job is overdue, but both levels may be used to provide individual status indicators for each media movement job.

The status for media jobs in the media job category may be determined 210 for all, or a subset, of the media jobs in the category. For example, in one embodiment, the status of all media jobs in the category having a due time within a predetermined time period (which may be a default time period or may have been specified in the service level objective) may be determined. After the status for media jobs in the media job category has been determined 210, a status indicator for the media job category is provided 215. The status indicator may be provided via user interface 104 or may be provided in another fashion, such as electronic notification. In some embodiments, an electronic notification may only be sent if the status is not okay. The status indicator may comprise of multiple status levels (e.g., an okay status, a warning status, and a critical status). Alternate status levels are also contemplated.

It should be appreciated that 210 and 215 may be repeated to update the status indicator. The status indicator may be updated on a periodic time basis, at the time a screen displaying the status indicator is accessed, or may be updated based on another type of trigger. Additionally, in some embodiments, the service level objective may be automatically configured with a default value and thus 205 may not be performed.

FIG. 3 illustrates an exemplary screen that may be provided to a user by user interface 104 to configure a service level objective for a media job category. Screen 300 may include an area 302 to enter the site for which the service level objective is being configured. Alternately, the service level objective may be a global objective that applies to all sites. In alternate embodiments, screen 300 may not include 302.

A second area 304 is provided for the user to enter the media job category to which the service level objective applies. By way of example, the media job category may be a media movement category (e.g., vault category, scratch category, check out request category), a device load category, and a scratch media initialization category.

A third area 306 is provided for the user to configure the service level objective for the media job category specified in 304. As illustrated in FIG. 3, the service level objective may be a percentage of media jobs associated with the category that are completed on time. The critical percentage of 95% shown in 304 would set a service level objective of completing 95% of vaulting jobs on time. A second warning percentage is configured using area 308. If the percentage of vaulting jobs completed on time falls below this percentage, a warning status indicator may be displayed to a user. Alternate embodiments may not include one or both of 306 and 308. Additionally, screen 300 may include other or alternate areas to configure different types of service level objectives.

Screen 300 may further include an area 310 to enter a time period over which to apply the service level objective to media jobs associated with the category. In other words, the time period limits the application of the service level objective to media jobs associated with the category having a due date (or some other criteria) within the time period specified by 310. By way of example, a critical status indicator may be provided 215 if the number of vaulting jobs having due dates within the past 30 days and that complete on time falls below 95%. Alternate embodiments may not include 310.

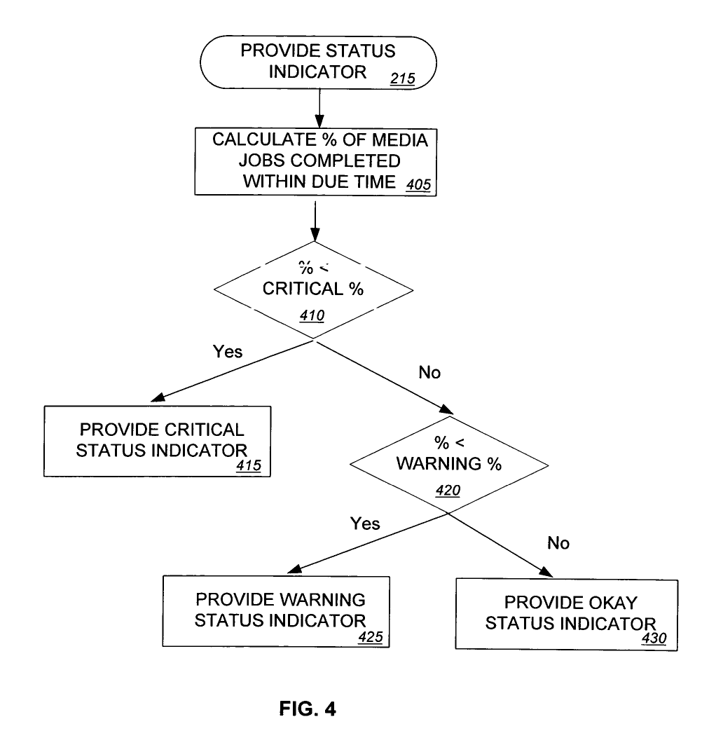

FIG. 4 illustrates an exemplary method that may use the method of FIG. 2 to provide a status indicator 215. After the status of each of the media jobs associated with the category has been determined 210, a percentage of media jobs that were completed within the due time is calculated 405. If the percentage is less than a critical percentage specified by the service level objective 410, a critical status indicator is provided 415. Otherwise, if the percentage is less than a warning percentage specified by the service level objective 420, but greater than the critical percentage, a warning status indicator is provided 425.

Finally, if the percentage of jobs that completed on time is greater than both the critical and the warning percentages, an okay status indicator may be provided 430. In alternate embodiments, only one level of service objective may be received and thus 420 and 425 may not be performed. Additionally, the criteria used to provide the status indicator 215 may vary depending on the service level agreement specified. Thus, it is contemplated that other methods may be used to provide the status indicator 215.

In some embodiments, service level objectives may be received for more than one type of media job category. Additionally, some media job categories may have multiple service level objectives. By way of example, different priorities of check out requests (e.g., high, medium, and low) may have different service level objectives. Similarly, vaulting jobs may have different service level objectives depending upon the location to which the media is being moved (e.g., onsite vs. offsite).

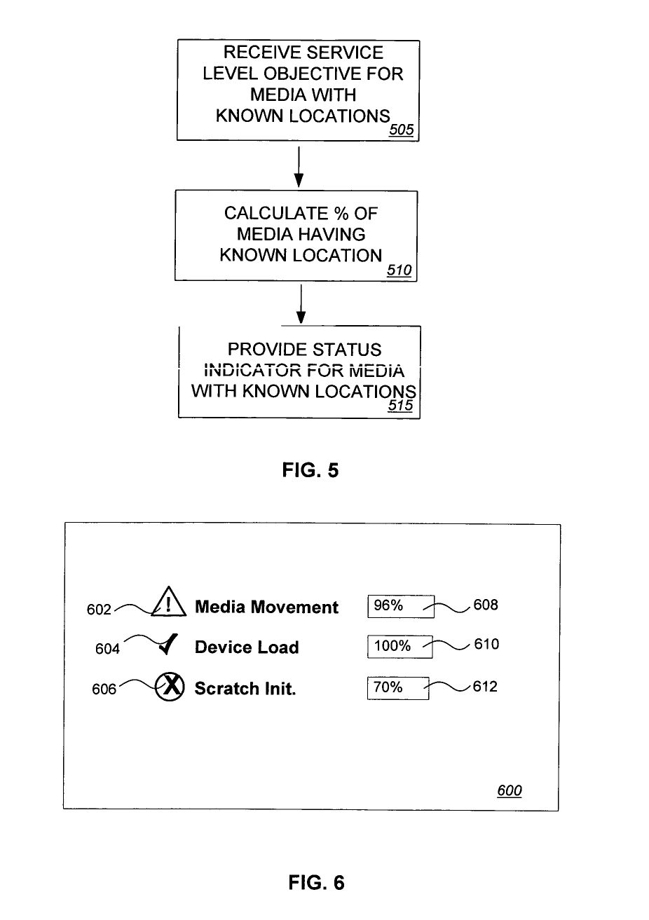

In one embodiment, a service level objective may be received for media with known locations. FIG. 5 illustrates an exemplary method that may be used to provide a status indicator based on the percentage of media that are in a known location (i.e., are not lost). At 505, a service level objective is received for media with a known location. The service level objective may be a desired percentage of media that should have a known location. As previously described, additional percentages may also be received to configure varying levels of the service level agreement (e.g., critical vs. warning).

Next, a percentage of media with a known location is calculated 510. A status indicator for media with known locations is then provided 515 based on the calculated percentage and the service level objective. A method similar to that described with reference to FIG. 4 may be used to provide the status indicator, with the calculation of media having a known location replacing 405.

FIG. 6 illustrates an exemplary screen 600 that may be used to present multiple status indicators 602, 604, 606 for multiple media job categories. Service level agreements for one or more media job categories, such as a media movement category, a device load category, and a scratch initialization category may have been received 205. A percentage of media jobs that were completed on time may be calculated 405 for each of the media job categories. This percentage may be displayed to a user with areas 608 (displaying percentage for media movement category), 610 (displaying percentage for device load category), and 612 (displaying percentage for scratch initialization category).

A method similar to that described with reference to FIG. 4 may be used to determine which status indicator to provide. A warning status indicator 602 is illustrated for the media movement category. An okay status indicator 604 is illustrated for the device load category, and critical status indicator is illustrated for the scratch initialization category. It should be appreciated that other symbols may be used for each of these status indicators 602, 604, 606, and that alternate embodiments may use different status indicators.

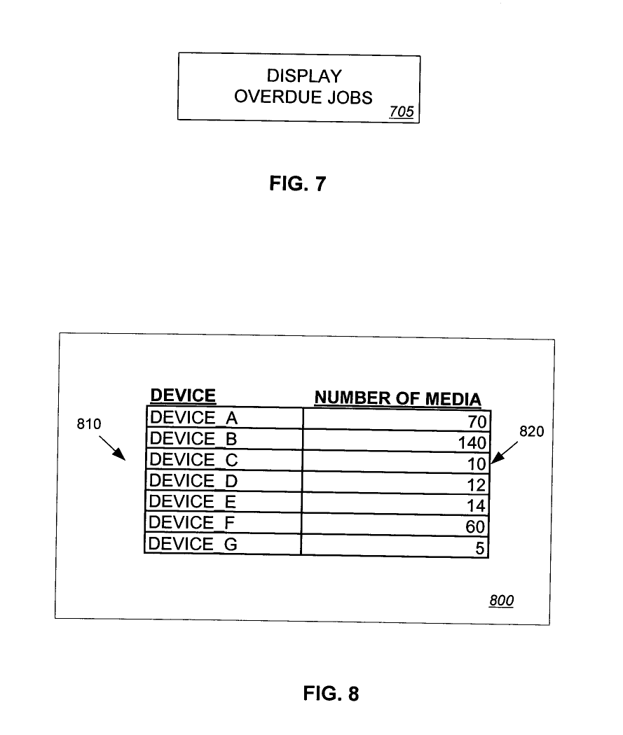

As shown in FIG. 7, in one embodiment, user interface 104 may be further configured to display 705 overdue jobs for the media job category. FIG. 8 illustrates an exemplary presentation 800 to a user of device load jobs that are overdue. A first column 810 is provided to list the device for which the media is to be loaded and a second column 820 is provided to list the number of media that needs to be loaded in the device. Alternately, the screen 800 may display this information by media pool (e.g., scratch bin). Additional information may also be displayed (e.g., the media operator responsible for the job).

It is contemplated that different screens may be provided by user interface 104 for different media job categories to display 705 overdue jobs for the category. Additionally, a screen may also be provided by user interface 104 to display a media exception list listing media that do not have a known location (i.e., lost media). This list may also include additional information, such as the last known location of the media and/or the last operator to handle the media.

It should be appreciated that the methods described above may be performed by hardware components or may be embodied in sequences of machine-executable instructions, which may be used to cause a machine, such as a general-purpose or special-purpose processor or logic circuits programmed with the instructions to perform the actions set forth in FIGS. 2, 4, 5, and 7. Alternatively, the methods may be performed by a combination of software, firmware, and hardware.

1. A method comprising:
receiving a service level objective for a media job category;
determining a status for each of a plurality of media jobs associated with the media job category; and
providing a status indicator for the media job category based on the service level objective and the status for each of the plurality of media jobs.

2. The method of claim 1, wherein determining a status comprises determining whether each of the plurality of media jobs completed within a due time for each respective media job.

3. The method of claim 1, wherein receiving a service level objective comprises receiving a first desired percentage of media jobs to be completed within a due time associated with the media job.

4. The method of claim 3, wherein providing a status indicator comprises:
calculating a calculated percentage of the plurality of media jobs that were completed within the due time associated with the media job;
if the calculated percentage is less than the first desired percentage, providing a critical status indicator.

5. The method of claim 3, further comprising receiving a second desired percentage of media jobs to be completed within the due time associated with the media job, the second desired percentage greater than the first desired percentage.

6. The method of claim 5, wherein providing a status indicator comprises:
calculating a calculated percentage of the plurality of media jobs that completed within the due time associated with the media job;
if the calculated percentage is less than the first desired percentage, providing a critical status indicator;
if the calculated percentage is greater than the first desired percentage and less than the second desired percentage, providing a warning status indicator; and
if the calculated percentage is greater than the second desired percentage, providing an OK status indicator.

7. The method of claim 1, further comprising:
receiving a second service level objective comprising a desired percentage of media to have a known location;
calculating a calculated percentage of media of a total number of media having a known location; and
providing a second status indicator for media having a known location based on the calculated percentage and the second service level objective.

8. The method of claim 1, wherein providing a status indicator comprises providing one of a critical status, a warning status, and an OK status.

9. The method of claim 1, wherein the media job category comprises one of a media movement category, a device load category, and a scratch media initialization category.

10. The method of claim 9, wherein the media movement category is one of a vaulting category for media jobs that move media having protected data to a different location, a scratch category for media jobs that move to move media having data that exceeded a protected time period to a scratch bin, and a check out request category for media check out jobs.

11. The method of claim 1, further comprising displaying one or more overdue media jobs associated with the media job category.

12. A system comprising:
a user interface to receive a service level objective for a media job category;
logic, communicatively coupled to said user interface, to determine a status for each of a plurality of media jobs associated with the media job category and to determine a status indicator for the media job category based on the service level objective and the status for each of the plurality of media jobs; and
wherein said user interface is further configured to provide the status indicator for the media job category.

13. The system of claim 12, further comprising:
media job information comprising a plurality of media jobs associated with the media job category, each of the plurality of media jobs having a due time; and
wherein said logic is to determine the status using said media job information.

14. The system of claim 13, wherein said media job information comprises information on at least one of a plurality of media movement jobs, a plurality of device load jobs, and a plurality of scratch media initialization jobs.

15. The system of claim 12, wherein said logic is further configured to calculate a calculated percentage of the plurality of media jobs that were completed within a due time associated with the media job.

16. The system of claim 12, wherein the service level objective comprises a desired percentage of media jobs to be completed within a due time associated with the media job and said logic is configured to determine a critical status indicator if the calculated percentage is less than the desired percentage.

17. At least one machine-readable medium having stored thereon sequences of instructions, which, when executed by a machine, cause the machine to perform the action of:
receiving a service level objective for a media job category;
determining a status for each of a plurality of media jobs associated with the media job category;
providing a status indicator for the media job category based on the service level objective and the status for each of the plurality of media jobs.

18. The medium of claim 17, wherein the instructions for providing a status indicator comprise which, when executed by the machine, cause the machine to perform the actions of:
calculating a calculated percentage of the plurality of media jobs that were completed within a due time for each respective media job;
if the calculated percentage is less than the service level objective, providing a critical status indicator, wherein the service level objective comprises a desired percentage of media jobs to be completed within the due time for each respective media job.

19. The medium of claim 17, further comprising instructions which, when executed by the machine, cause the machine to perform the actions of:
receiving a second service level objective comprising a desired percentage of media to have a known location; and
calculating a calculated percentage of media of a total number of media having a known location; and
providing a second status indicator for media having a known location based on the calculated percentage and the second service level objective.

20. The medium of claim 22, further comprising instructions which, when executed by the machine, cause the machine to perform the action of displaying one or more overdue media jobs associated with the media job category.
